(19) United States
(12) Patent Application Publication
(10) Pub. No.: US 2026/0229024 A1
(43) Pub. Date: Aug. 6, 2026

(54) INFORMATION PROCESSING APPARATUS, INFORMATION PROCESSING METHOD, AND NON-TRANSITORY COMPUTER READABLE MEDIUM

(71) Applicant: RAKUTEN GROUP, INC., Tokyo (JP)

(72) Inventors: Geethu JACOB, Tokyo (JP); Poulami RAHA, Tokyo (JP); Dhananjay NAHATA, Tokyo (JP)

(73) Assignee: RAKUTEN GROUP, INC., Tokyo (JP)

(21) Appl. No.: 18/697,231

(22) PCT Filed: Mar. 31, 2023
(86) PCT No.: PCT/JP2023/013494

§ 371 Date: Apr. 13, 2026

(51) Int. Cl. G06V 10/778; G06V 10/774; G06V 10/82; G06V 20/60

(52) U.S. Cl. CPC G06V 10/778; G06V 10/774; G06V 20/60; G06V 10/82

(57) ABSTRACT

An information processing apparatus includes a training unit configured to train an attribute prediction model for predicting, from an image containing a product, N (N is an integer of 2 or more) attributes of the product. The training unit includes: a first training unit configured to train an i-th (i is an integer of 1 to N−1) learning model for predicting an i-th attribute of the product, using i-th training data corresponding to the i-th attribute; and a second training unit configured to train the attribute prediction model using the i-th learning model trained by the first training unit, part of the i-th training data, and N-th training data corresponding to an N-th attribute of the product.

### TECHNICAL FIELD

The present invention relates to an information processing apparatus, an information processing method, and an information processing program, and in particular to a technique for predicting attributes of a product from an image containing the product.

### BACKGROUND ART

In recent years, electronic commerce (EC), which uses the Internet to conduct sales of commercial products, is being actively operated, and many EC sites have been constructed on the Web to conduct such electronic commerce. EC sites are often constructed in the languages of countries around the world, enabling users (consumers) resident in many countries to purchase products. Users can access EC sites from their personal computers (PCs) or mobile terminals such as smartphones to select and purchase desired products at all hours, without visiting actual stores.

In an EC site, there may be a case where, to increase buying motives of users, products having the same attributes as the attributes of products (information specific to the products) that the users have purchased in the past are displayed on the screen that the users are browsing, as products to be recommended. Also, when purchasing a desired product, users may search for the desired product based on the attributes of the product that the users are to purchase. In such circumstances, in electronic commerce, it is a common challenge for site operators and product providers to identify the attributes of products.

In recent years, techniques have been developed to predict attributes of a product from an image containing the product, using a learning model for machine learning. For example, Patent Literature Document 1 discloses a technique for predicting a plurality of attributes of a product by applying an image containing the product to a learning model configured using a neural network.

### LISTING OF REFERENCES

### Patent Literature Document

Patent Literature Document 1: JP 2020-71859A

### SUMMARY OF THE INVENTION

### Problems to be Solved by the Invention

According to the technique disclosed in Patent Literature Document 1, applying an image containing a product to a learning model automatically enables prediction of a plurality of attributes of the product. On the other hand, the types and the number of products handled in electronic commerce are increasing, resulting in an increase in the types of attributes. Accordingly, it is desirable to construct a learning model that predicts, from an image containing a product, not only existing attributes of the product but also new attributes.

A method called incremental learning is known, in which additional training data is continuously used to train a learning model so that the learning model learns a new task. According to incremental learning, by training a learning model using additional training data having new attributes, it is possible to construct the learning model that can predict not only already learned attributes but also newly learned attributes.

However, when additional training data is continuously used to train a learning model, this causes the problem of catastrophic forgetting, in which a learning model “forgets” data learned in the past. For example, situations may occur in which an error between data learned in the past and correct answer data increases, an error increases, or data learned in the past is completely forgotten.

The present invention was made in view of the above-described problem, and it is an object thereof to provide a technique for realizing learning of new attributes of a product from an image containing the product, while preventing catastrophic forgetting.

### Solution to the Problems

An information processing apparatus according to an aspect of the present invention includes a training unit configured to train an attribute prediction model for predicting, from an image containing a product, N (N is an integer of 2 or more) attributes of the product, wherein the training unit includes: a first training unit configured to train an i-th (i is an integer of 1 to N−1) learning model for predicting an i-th attribute of the product, using i-th training data corresponding to the i-th attribute; and a second training unit configured to train the attribute prediction model using the i-th learning model trained by the first training unit, part of the i-th training data, and N-th training data corresponding to an N-th attribute of the product.

An information processing method according to an aspect of the present invention is an information processing method for training an attribute prediction model for predicting, from an image containing a product, N (N is an integer of 2 or more) attributes of the product, the method includes the steps of: training an i-th (i is an integer of 1 to N−1) learning model for predicting an i-th attribute of the product, using i-th training data corresponding to the i-th attribute; and training the attribute prediction model using the i-th learning model trained by the first training unit, part of the i-th training data, and N-th training data corresponding to an N-th attribute of the product.

An information processing program according to an aspect of the present invention is an information processing program for training an attribute prediction model for predicting, from an image containing a product, N (N is an integer of 2 or more) attributes of the product, the program causes a computer to execute the steps of: training an i-th (i is an integer of 1 to N−1) learning model for predicting an i-th attribute of the product, using i-th training data corresponding to the i-th attribute; and training the attribute prediction model using the i-th learning model trained by the first training unit, part of the i-th training data, and N-th training data corresponding to an N-th attribute of the product.

### Advantageous Effects of the Invention

According to the present invention, it is possible to realize learning of new attributes of a product from an image containing the product, while preventing catastrophic forgetting.

The object, aspects, and effects of the present invention described above, as well as objects, aspects, and effects of the present invention that are not described above can be understood by those skilled in the art from the embodiments of the present invention described below by referring to the accompanying drawings and the scope of the claims.

### BRIEF DESCRIPTION OF THE DRAWINGS

FIG. 1 shows an example of a configuration of a natural language processing system according to an embodiment.

FIG. 2 shows an example of a hardware configuration of the information processing apparatus according to the embodiment.

FIG. 3A is a diagram illustrating attributes of products.

FIG. 3B shows a relationship between a product image and attributes.

FIG. 4 is a conceptual diagram showing attribute training data.

FIG. 5A shows a procedure of training a learning model with respect to a first attribute in a first time step.

FIG. 5B shows a procedure of training learning models with respect to the first attribute to a second attribute in a second time step.

FIG. 5C shows a procedure of training learning models with respect to the first attribute to a third attribute in a third time step.

FIG. 5D is a diagram illustrating a procedure of training learning models with respect to the first attribute to an N-th attribute in an N-th time step.

FIG. 6A is a flowchart of learning processing of an attribute prediction model executed by the information processing apparatus according to the embodiment.

FIG. 6B is a flowchart illustrating a modification of the processing of training the attribute prediction model executed by the information processing apparatus according to the embodiment.

FIG. 7 is a flowchart illustrating attribute prediction processing executed by the information processing apparatus according to the embodiment.

### DESCRIPTION OF EMBODIMENTS

Embodiments of the present invention will now be described in detail with reference to the accompanying drawings. Out of the component elements described below, elements with the same functions have been assigned the same reference numerals, and description thereof is omitted. Note that the embodiments disclosed below are mere example implementations of the present invention, and it is possible to make changes and modifications as appropriate according to the configuration and/or various conditions of the apparatus to which the present invention is to be applied. Accordingly, the present invention is not limited to the embodiments described below. The combination of features described in these embodiments may include features that are not essential when implementing the present invention.

### Functional Configuration of Information Processing Apparatus

An information processing apparatus 100 according to the present embodiment acquires an image (hereinafter, referred to also as a product image) containing a product (i.e., showing the product) and predicts a plurality of attributes of the product. The attributes of a product are information specific to the product, and are visual features of the product, for example. The attributes of a product can be an indicator when a user purchases this product. Note that the present embodiment describes an example in which the attributes of a product are predicted, but the present embodiment is also applicable to a case where the attributes of a suitable item including a product, from an image containing the item (i.e., showing the item).

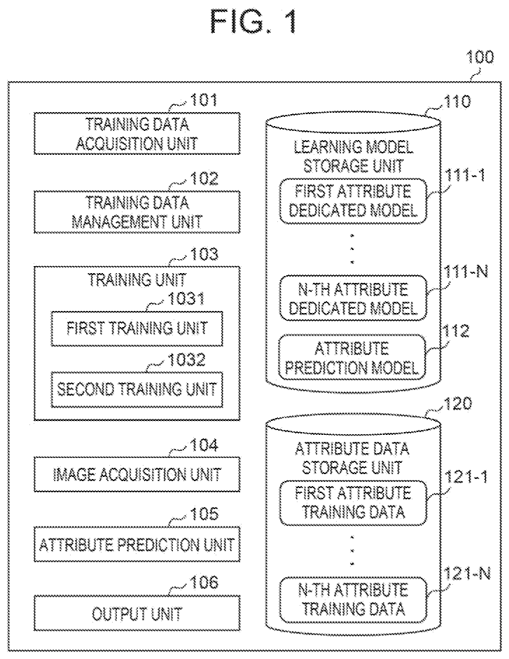

FIG. 1 shows an example of a functional configuration of the information processing apparatus 100 according to the present embodiment.

The information processing apparatus 100 includes a training data acquisition unit 101, a training data management unit 102, a training unit 103, an image acquisition unit 104, attribute prediction unit 105, an output unit 106, a learning model storage unit 110, and an attribute data storage unit 120. The training unit 103 includes a first training unit 1031 and a second training unit 1032. The learning model storage unit 110 is configured to store a first attribute dedicated model 111-1 to an N-th attribute dedicated model 111-N, and an attribute prediction model 112. The attribute data storage unit 120 is configured to store first attribute training data 121-1 to N-th attribute training data 121-N. In the present disclosure, “N” is an integer of 2 or more.

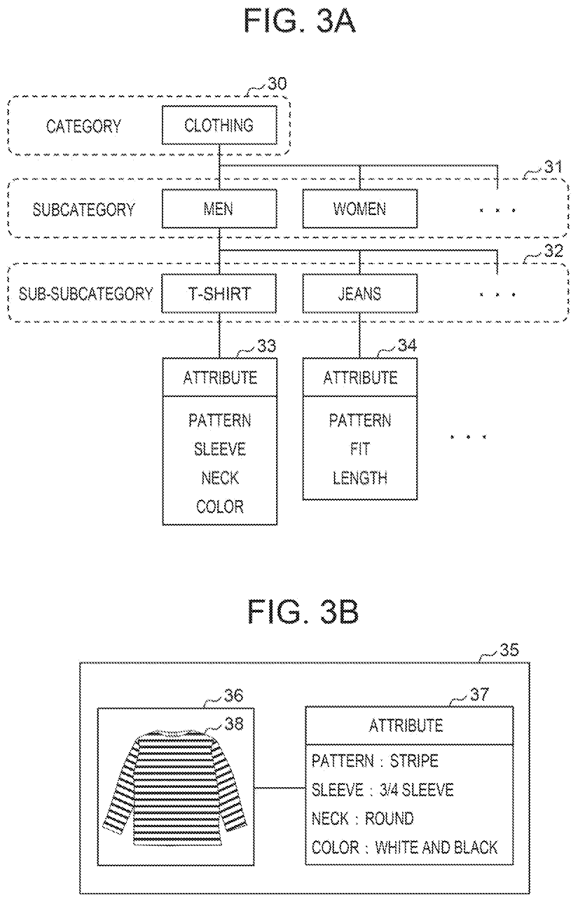

The training data acquisition unit 101 acquires training data (teaching data) for training a learning model. In the present embodiment, training data contains an image of a product, and correct answer data for the attributes of the product. The following describes examples of the attributes of products in the present embodiment with reference to FIG. 3A. FIG. 3A is a diagram illustrating the attributes of products.

In the present embodiment, products are considered as products that can be handled in electronic commerce (EC) sites. Due to the variety of types and the large number of products that can be handled in EC sites, product attributes are set for classified products (group of products). Classification of products can be hierarchical. The present embodiment assumes attributes of products whose product category representing the upper classification, among the classification of the products, is “clothing”.

In FIG. 3A, products whose product category 30 is “clothing” are classified into subcategories 31, which are sub-classifications of the category 30, and into sub-subcategories 32, which are sub-classifications of the subcategories 31. The subcategories 31 indicate subjects that wear the “clothing”, and include “men” and “women” in the example shown in FIG. 3A. In addition thereto, the subcategories 31 may include “children”, “seniors”, “unisex”, which is gender-neutral concept, and the like. The sub-subcategories 32 indicate the types and shapes of the “clothing”. In the case of “male” of the subcategory 31, the sub-subcategory 32 includes “T-shirts” and “jeans”. In addition thereto, in the case of “male” of the subcategory 31, the sub-subcategory 32 may include “jackets”, “coats” and the like.

In the example of FIG. 3A, attributes are set for the products of the sub-subcategory 32. In the case of “T-shirts” of the sub-subcategory 32, the attributes include “pattern”, “sleeve”, “neck shape”, and “color”. Also, in the case of “jeans” of the sub-subcategory 32, the attributes include “pattern”, “fit”, and “length”. Note that the types of the attributes of the products shown in FIG. 3A are examples, and are not limited to the shown types. Also, the number of attributes may further increase in the future. Although, in FIG. 3A, the attributes are set for the products of the sub-subcategory 32, attributes may also be set for the subcategory 31 or the category 30.

FIG. 3B shows a relationship between a product image and attributes. FIG. 3B shows data 35 that contains attributes 37 of a product 38 included in a product image 36. The product 38 is a product classified into “clothing” of the category 30, “male” of the subcategory 31, and “T-shirts” of the sub-subcategory 32 in FIG. 3A, and the attributes 37 include “pattern”, “sleeve”, “neck shape”, and “color”, with reference to FIG. 3A. Furthermore, each of the attributes 37 has a feature (feature value) regarded as a correct answer (hereinafter, referred to also as correct answer feature). The correct answer features of the attributes of the product 38 in the product image 36 are as shown in FIG. 3B, and the correct answer feature of “pattern” is “stripe”, the correct answer feature of “sleeve” is “3/4 sleeve”, the correct answer feature of “neck shape” is “round”, and the correct answer feature of “color” is “white and black”.

As described above, training data contains an image of a product, and correct answer data of the attributes of the product. The training data acquisition unit 101 generates and acquires training data based on the data 35 shown in FIG. 3B, for example. When an attribute of the product 38 shown in FIG. 3B is “pattern”, possible features of “pattern” are defined as “stripe”, “plain”, “check”, “dot”, and “print”, for example. In a case of classification problem, each piece of correct answer data for learning is 1 or 0. That is to say, there are two options, namely, 100% (correct answer feature) or 0% (non-correct answer feature). Since the “pattern” of the product 38 included in the product image 36 is “stripe”, the first feature in the order of “stripe”, “plain”, “check”, “dot”, and “print” is the correct answer feature. Accordingly, the correct answer data is given in the form of, for example, a probability distribution like {1, 0, 0, 0, 0}.

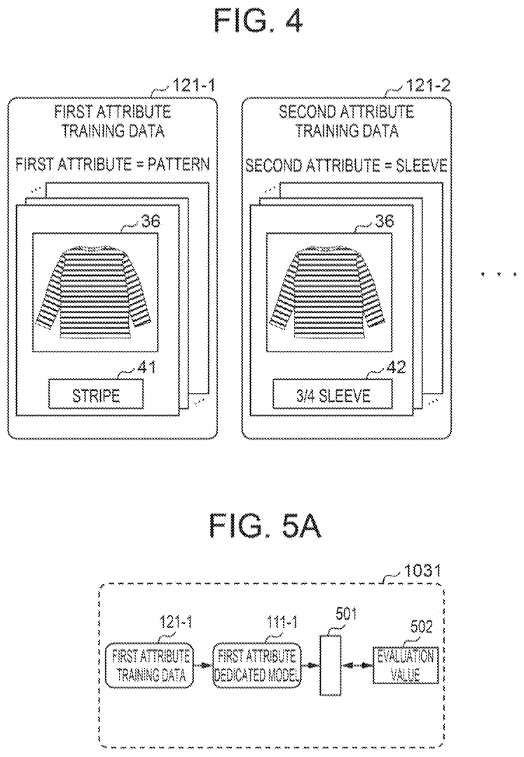

The training data management unit 102 stores the training data acquired by the training data acquisition unit 101, as attribute training data with respect to each attribute, in the attribute data storage unit 120. Referring to FIG. 3B, the training data management unit 102 stores a combination of the product image 36 and the correct answer data of the attributes 37 (that is, “pattern”, “sleeve”, “neck shape”, and “color”), as attribute training data with respect to each attribute, in the attribute data storage unit 120. FIG. 4 is a conceptual diagram showing attribute training data stored in the attribute data storage unit 120.

As shown in FIG. 1, the attribute data storage unit 120 is configured to store the first attribute training data 121-1 to the N-th attribute training data 121-N. For description, it is assumed that the first attribute is “pattern” and the second attribute is “sleeve”. The training data management unit 102 classifies, based on the data 35 shown in FIG. 3B, data on a combination of the product image 36 and correct answer data in which “stripe” 41 is “1” into the first attribute training data 121-1. Also, the training data management unit 102 classifies a combination of the product image 36 and correct answer data in which “¾ sleeve” 42 is “1” into the second attribute training data 121-2. In this manner, the training data management unit 102 extracts, from training data acquired by the training data acquisition unit 101, a product image and at least one attribute, and classifies a combination of the product image and correct answer data, with respect to each attribute, into any one of the first attribute training data 121-1 to the N-th attribute training data 121-N. With this, in each of the first attribute training data 121-1 to the N-th attribute training data 121-N, a set of data on combinations of a product image and correct answer data of a first attribute to an N-th attribute of a product contained in this image.

Note that although, in the present embodiment, the training data management unit 102 is configured to store training data acquired by the training data acquisition unit 101, with respect to each attribute, in the attribute data storage unit 120, the procedure of storing the data in the attribute data storage unit 120 is not limited to this. For example, when the training data acquisition unit 101 acquires a product image and the correct answer feature of one attribute, the training data management unit 102 may store data on a combination of the product image and correct answer data corresponding to the correct answer feature, based on this attribute, in any one of the first attribute training data 121-1 to the N-th attribute training data 121-N. Alternatively, in this case, the training data acquisition unit 101 may directly store this combination data in any one of the first attribute training data 121-1 to the N-th attribute training data 121-N.

Furthermore, the training data management unit 102 manages, among the first attribute training data 121-1 to the N-th attribute training data 121-N stored in the attribute data storage unit 120, a piece of data to be supplied to the training unit 103. Taking the first attribute training data 121-1 as an example, the training data management unit 102 can supply a full set of first attribute training data 121-1 to the training unit 103. Alternatively, the training data management unit 102 can select (sample) part of the first attribute training data 121-1 and supply the selected part of data to the training unit 103. The part of data may be randomly selected, or may be selected in accordance with a predetermined rule. In the present disclosure, the expression “a full set of data” means that the data has a larger data amount than that of “part of data” (for example, it includes a set of larger amount of training data). The training data management unit 102 can supply attribute training data to the training unit 103 in response to a request from the training unit 103.

Returning to the description of FIG. 1, the training unit 103 trains the first attribute training data 121-1 to the N-th attribute training data 121-N, and the attribute prediction model 112. These learning models may be constructed using a convolutional neural network (CNN). The training unit 103 includes a first training unit 1031 and a second training unit 1032, and performs overall control of training processing including control of the first training unit 1031 and the second training unit 1032. The first training unit 1031 is configured to train the first attribute dedicated model 111-1 to the N-th attribute dedicated model 111-N. The second training unit 1032 is configured to train the attribute prediction model 112 using at least one of the trained first attribute dedicated model 111-1 to N-th attribute dedicated model 111-N. The procedure of training the first attribute dedicated model 111-1 to the N-th attribute dedicated model 111-N and the attribute prediction model 112 by the training unit 103 will be described later.

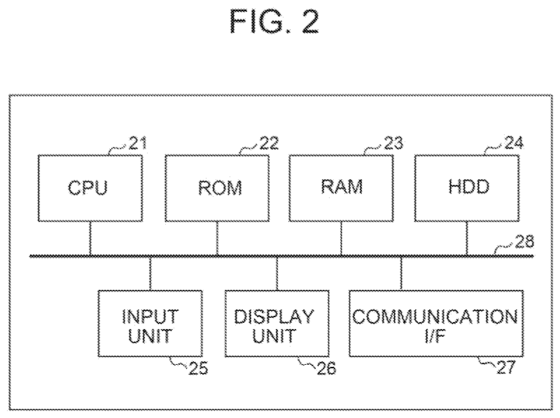

The image acquisition unit 104 acquires a product image containing a target product (that is, product to be subjected to attribute prediction). The image acquisition unit 104 may acquire the product image through an input operation of a user (operator) via an input unit 25 (FIG. 2), or may acquire the product image from a storage unit (such as a ROM 22 or a RAM 23 in FIG. 2) through a user operation. Also, the image acquisition unit 104 may acquire the product image received from an external apparatus via a communication I/F 27 (FIG. 2).

The attribute prediction unit 105 applies the product image acquired by the image acquisition unit 104 to the trained attribute prediction model 112, and predicts a plurality of attributes of a target product contained in the product image.

The output unit 106 outputs information (attribute prediction result) on the attributes predicted by the attribute prediction unit 105. The output unit 106 may output the attribute production result in association with the product image acquired by the image acquisition unit 104, for example. The output unit 106 may display the attribute production result on a display unit 26 (FIG. 2). Also, when the product image has been acquired from an external apparatus such as a user apparatus, the output unit 106 may transmit an attribute production result to the external apparatus via the communication I/F 27 (FIG. 2) so that it is displayed on a display unit of the external apparatus.

### Hardware Configuration of Information Processing Apparatus

FIG. 2 is a block diagram showing an example of the hardware configuration of the information processing apparatus 100 according to the present embodiment. The information processing apparatus 100 can be implemented on a single or a plurality of any computers, mobile devices, or other processing platforms.

Although FIG. 2 shows an example in which the information processing apparatus 100 is implemented on a single computer, the information processing apparatus 100 of the present embodiment may be implemented on a computer system including a plurality of computers. The plurality of computers may be connected to each other via a wired or wireless network to enable communication between the computers.

As shown in FIG. 2, the information processing apparatus 100 may include a CPU (Central Processing Unit) 21, the ROM (Read Only Memory) 22, the RAM (Random Access Memory) 23, an HDD (Hard Disk Drive) 24, the input unit 25, the display unit 26, the communication I/F 27, and a system bus 28. The information processing apparatus 100 may also include an external memory.

The CPU 21 is adapted to perform overall control of operations of the information processing apparatus 100 and controls the constituent components (22 to 27) via the system bus 28, which is a data transmission path. The CPU 21 is configured by one or more processors. At least one of the one or more processors may be replaced by one or more processors such as an Application Specific Integrated Circuit (ASIC), a Field Programmable Gate Array (FPGA), a Digital Signal Processor (DSP), or a Graphics Processing Unit (GPU).

The ROM 22 is a nonvolatile memory that stores control programs and the like that the CPU 21 needs to execute processing. Note that the programs may also be stored in a nonvolatile memory, such as the HDD 24, an SSD (Solid State Drive), or an external memory such as a removable storage medium (not shown).

The RAM 23 is a volatile memory and functions as the main memory, work area, and the like of the CPU 21. That is to say, when executing processing, the CPU 21 loads a required program or the like from the ROM 22 into the RAM 23 and executes the program or the like to realize various functional operations. The learning model storage unit 110 and the attribute data storage unit 120 shown in FIG. 1 may be constituted by the RAM 23.

The HDD 24 stores, for example, various data, various information, and the like that the CPU 21 needs to perform processing using a program. The HDD 24 also stores various data, various information, and the like obtained by the CPU 21 performing processing using a program or the like.

The input unit 25 is composed of a keyboard, and a pointing device such as a mouse.

The display unit 26 is composed of a monitor, such as a liquid crystal display (LCD). When configured in combination with the input unit 25, the display unit 26 may also function as a GUI (Graphical User Interface).

The communication I/F 27 is an interface that controls communication between the information processing apparatus 100 and external apparatuses.

The communication I/F 27 provides an interface with a network and executes communication with external apparatuses via the network. Various data, various parameters, and the like are transmitted and received to and from the external apparatuses via the communication I/F 27. In the present embodiment, the communication I/F 27 may perform communication via a wired LAN (Local Area Network) or a dedicated line that complies with a communication standard, such as Ethernet (registered trademark). However, the network that can be used in the present embodiment is not limited to this and may be configured as a wireless network. This wireless network includes a wireless PAN (Personal Area Network) such as Bluetooth (registered trademark), ZigBee (registered trademark), and UWB (Ultra Wide Band). The wireless network also includes a wireless LAN (Local Area Network) such as Wi-Fi (Wireless Fidelity) (registered trademark), and a wireless MAN (Metropolitan Area Network) such as WiMAX (registered trademark). The wireless network further includes a wireless WAN (Wide Area Network) such as 4G or 5G specified by 3GPP (Third Generation Partnership Project) (registered trademark). Note that it is sufficient for the network to connect devices to enable communication between them, and the communication standard, scale, and configuration are not limited to the above examples.

At least some of the functions of the information processing apparatus 100 shown in FIG. 1 can be realized by the CPU 21 executing a program. However, at least some of the functions of the information processing apparatus 100 shown in FIG. 1 may operate as dedicated hardware. In this case, the dedicated hardware may operate under the control of the CPU 21.

### Procedure of Training Learning Model

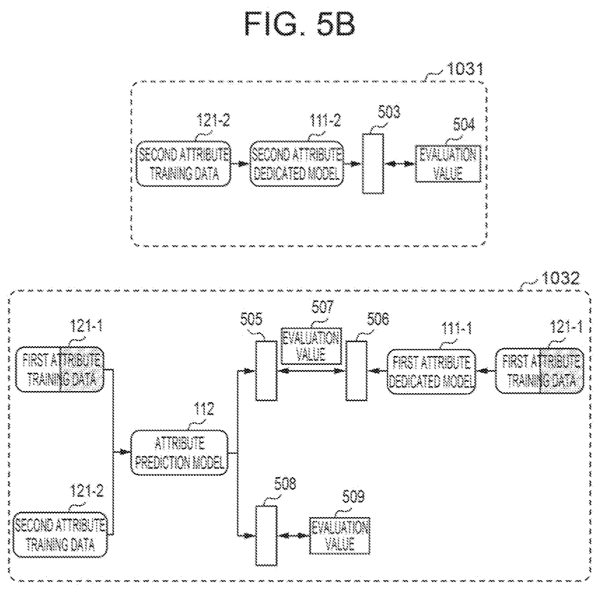

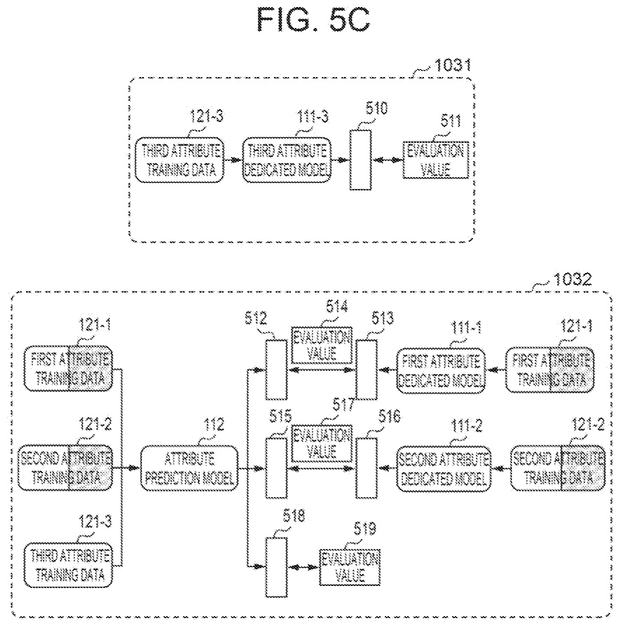

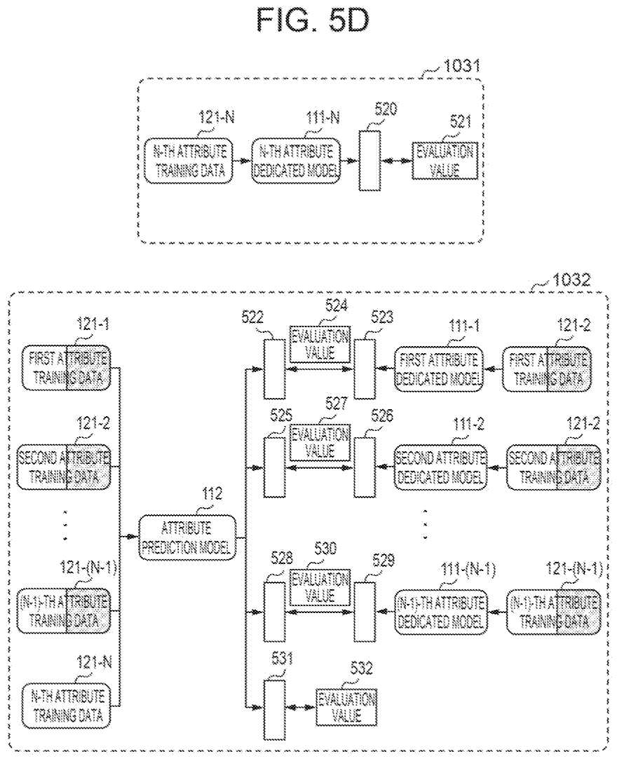

The following will describe procedures in which the training unit 103 trains learning models, with reference to FIGS. 5A to 5D. In the present embodiment, the training unit 103 executes incremental learning, in which additional training data is continuously used to train a learning model. FIG. 5A shows a procedure of training a learning model with respect to a first attribute in a first time step. FIG. 5B shows a procedure of training learning models with respect to the first attribute to a second attribute in a second time step. FIG. 5C shows a procedure of training learning models with respect to the first attribute to a third attribute in a third time step. FIG. 5D is a diagram illustrating a procedure of training learning models with respect to the first attribute to an N-th attribute in an N-th time step. Here, the terms “time step” are to be understood as terms expressing relative time instead of a specific time (or a period of time).

First, the training procedure in the first time step is described with reference to FIG. 5A. In the first time step, the first training unit 1031 applies the first attribute training data 121-1 stored in the attribute data storage unit 120 to the first attribute dedicated model 111-1 and trains the first attribute dedicated model 111-1. To train the first attribute dedicated model 111-1, a full set of first attribute training data 121-1 is used. Therefore, for example, the first training unit 1031 can request the training data management unit 102 for the full set of first attribute training data 121-1. In response thereto, the training data management unit 102 can supply the full set of first attribute training data 121-1 to the first training unit 1031.

The first training unit 1031 inputs a product image contained in the first attribute training data 121-1 to the first attribute dedicated model 111-1, and obtains, as an output 501 (estimation result), a probability distribution of features that the first attribute can have (hereinafter, referred to also as estimation probability distribution). If, for example, the first attribute is “pattern”, the features that “pattern” can have are assumed to be, e.g., “stripe”, “plain”, “check”, “dot”, and “print”, as described above. The output 501 is an estimation probability distribution in this order and is {0.6, 0.1, 0.1, 0.1, 0.1}, for example. Also, as described above, in the case of the data 35 shown in FIG. 3B, the correct answer probability distribution indicating whether or not it is correct answer data is {1, 0, 0, 0, 0}.

The first training unit 1031 obtains, with respect to the entire first attribute training data 121-1, the output 501 (estimation probability distribution) and the correct answer probability distribution, and calculates an evaluation value (evaluation function) 502 based on the output 501 and the correct answer probability distribution. In the present embodiment, a cross entropy (CE) (referred to also as a cross-entropy loss) is used as an evaluation value for use in training an attribute dedicated model such as the first attribute dedicated model 111-1. The first training unit 1031 trains the first attribute dedicated model 111-1 based on the evaluation value 502 (so that the evaluation value 502 is minimized, for example). The first training unit 1031 stores the trained first attribute dedicated model 111-1 in the learning model storage unit 110. The trained first attribute dedicated model 111-1 is used in the training processing in the second time step.

Then, the training procedure in the second time step is described with reference to FIG. 5B. In the second time step, the first training unit 1031 applies the second attribute training data 121-2 stored in the attribute data storage unit 120 to the second attribute dedicated model 111-2 and trains the second attribute dedicated model 111-2. Similar to the procedure described with reference to FIG. 5A, to train the second attribute dedicated model 111-2, a full set of second attribute training data 121-2 is used. Therefore, for example, the first training unit 1031 can request the training data management unit 102 for the full set of second attribute training data 121-2. In response thereto, the training data management unit 102 can supply the full set of second attribute training data 121-2 to the first training unit 1031.

The first training unit 1031 inputs a product image contained in the second attribute training data 121-2 to the second attribute dedicated model 111-2, and obtains, as an output 503, an estimation probability distribution with respect to the second attribute. Similar to the processing in the first time step, the first training unit 1031 obtains, with respect to the entire second attribute training data 121-2, the output 503 (estimation probability distribution) and the correct answer probability distribution, and calculates an evaluation value 504 (for example, a cross entropy) based on the output 503 and the correct answer probability distribution. The first training unit 1031 trains the second attribute dedicated model 111-2 based on the evaluation value 504 (so that the evaluation value 504 is minimized, for example). The first training unit 1031 stores the trained second attribute dedicated model 111-2 in the learning model storage unit 110. The trained second attribute dedicated model 111-2 is used in the training processing in the third time step.

Furthermore, in the second time step, the second training unit 1032 trains the attribute prediction model 112. The attribute prediction model 112 in the second time step is a learning model for predicting a first attribute and a second attribute. The second training unit 1032 applies the first attribute training data 121-1 and the second attribute training data 121-2 stored in the attribute data storage unit 120 to the attribute prediction model 112 and trains the attribute prediction model 112. To train the attribute prediction model 112, part of the first attribute training data 121-1 and a full set of second attribute training data 121-2 are used. Therefore, for example, the second training unit 1032 can request the training data management unit 102 for part of the first attribute training data 121-1 and the full set of second attribute training data 121-2. In response thereto, the training data management unit 102 can supply the part of the first attribute training data 121-1 and the full set of second attribute training data 121-2 to the second training unit 1032. Note that in the drawings of the present disclosure, the hatched parts of the regions of the attribute training data mean that they are parts of the corresponding attribute training data.

The second training unit 1032 inputs a product image contained in the part of the first attribute training data 121-1 to the attribute prediction model 112, and obtains, as an output 505, an estimation probability distribution with respect to the first attribute. Also, the second training unit 10302 inputs a product image contained in the part of the first attribute training data 121-1 to the first attribute dedicated model 111-1, and obtains, as an output 506, an estimation probability distribution with respect to the first attribute. The second training unit 1032 obtains, with respect to the entirety of the part of the first attribute training data 121-1, the output 505 (estimation probability distribution) and the output 506 (estimation probability distribution), and calculates an evaluation value 507, which indicates the degree of similarity, based on the output 505 and the output 506. In the present embodiment, a KL (Kullback-Leibler) divergence (referred to also as a KL divergence loss) is used as an evaluation value indicating the degree of similarity. The second training unit 1032 trains the attribute prediction model 112 so that the output 505 and the output 506 match each other (in other words, the degree of similarity is high). When a KL divergence is used as the evaluation value 507, the second training unit 1032 trains the attribute prediction model 112 so that the evaluation value 507 is minimized.

In this way, the second training unit 1032 trains the attribute prediction model 112 so that the output 505 from the first attribute dedicated model 111-1 and the output 506 from the attribute prediction model 112 match each other. In other words, the second training unit 1032 performs so-called knowledge distillation, in which a learning model is trained so that an output from a dedicated model (in the example of FIG. 5B, the first attribute dedicated model 111-1) trained exclusive for a predetermined attribute and an output from the learning model to be trained (in the example of FIG. 5B, the attribute prediction model 112) match each other.

Furthermore, the second training unit 1032 inputs a product image contained in the full set of second attribute training data 121-2 to the attribute prediction model 112, and obtains, as an output 508, an estimation probability distribution with respect to the second attribute. The second training unit 1032 obtains, with respect to the entire second attribute training data 121-2, the output 508 (estimation probability distribution) and the correct answer probability distribution, and calculates an evaluation value 509 (for example, a cross entropy) based on the output 508 and the correct answer probability distribution. The second training unit 1032 trains the attribute prediction model 112 based on the evaluation value 509 (so that the evaluation value 509 is minimized, for example).

In this way, the second training unit 1032 can train the attribute prediction model 112 using knowledge distillation, making it possible to prevent the model from forgetting a task for the already learned first attribute. The second training unit 1032 stores the trained attribute prediction model 112 in the learning model storage unit 110.

Then, the training procedure in the third time step is described with reference to FIG. 5C. In the third time step, the first training unit 1031 applies the third attribute training data 121-3 stored in the attribute data storage unit 120 to the third attribute dedicated model 111-3, and trains the third attribute dedicated model 111-3. Similar to the procedure described with reference to FIG. 5A, to train the third attribute dedicated model 111-3, a full set of third attribute training data 121-3 is used. Therefore, for example, the first training unit 1031 can request the training data management unit 102 for the full set of third attribute training data 121-3. In response thereto, the training data management unit 102 can supply the full set of third attribute training data 121-3 to the first training unit 1031.

The first training unit 1031 inputs a product image contained in the third attribute training data 121-3 to the third attribute dedicated model 111-3, and obtains, as an output 510, an estimation probability distribution with respect to a third attribute. Similar to the processing in the first time step, the first training unit 1031 obtains, with respect to the entire third attribute training data 121-3, the output 510 (estimation probability distribution) and the correct answer probability distribution, and calculates an evaluation value 511 (for example, a cross entropy) based on the output 510 and the correct answer probability distribution. The first training unit 1031 trains the third attribute dedicated model 111-3 based on the evaluation value 511 (so that the evaluation value 511 is minimized, for example). The first training unit 1031 stores the trained third attribute dedicated model 111-3 in the learning model storage unit 110. The trained third attribute dedicated model 111-3 is used in training processing in a fourth time step.

Furthermore, in the third time step, the second training unit 1032 trains the attribute prediction model 112. The attribute prediction model 112 in the third time step is a learning model for predicting the first attribute to the third attribute. The second training unit 1032 applies the first attribute training data 121-1, the second attribute training data 121-2, and the third attribute training data 121-3 that are stored in the attribute data storage unit 120 to the attribute prediction model 112, and trains the attribute prediction model 112. To train the attribute prediction model 112, part of the first attribute training data 121-1, part of the second attribute training data 121-2, and a full set of third attribute training data 121-3 are used. Therefore, for example, the second training unit 1032 can request the training data management unit 102 for part of the first attribute training data 121-1, part of the second attribute training data 121-2, and the full set of third attribute training data 121-3. In response thereto, the training data management unit 102 can supply the part of the first attribute training data 121-1, the part of the second attribute training data 121-2, and the full set of third attribute training data 121-3 to the second training unit 1032.

The second training unit 1032 inputs a product image contained in the part of the first attribute training data 121-1 to the attribute prediction model 112, and obtains, as an output 512, an estimation probability distribution with respect to the first attribute. Also, the second training unit 1032 inputs a product image contained in the part of the first attribute training data 121-1 to the first attribute dedicated model 111-1, and obtains, as an output 513, an estimation probability distribution with respect to the first attribute. The second training unit 1032 obtains, with respect to the entirety of the part of the first attribute training data 121-1, the output 512 (estimation probability distribution) and the output 513 (estimation probability distribution), and calculates an evaluation value 514 (e.g., a KL divergence) based on the output 512 and the output 513. The second training unit 1032 trains the attribute prediction model 112 based on the evaluation value 514 (so that the evaluation value 514 is minimized, for example). Also, the second training unit 1032 inputs a product image contained in the part of the second attribute training data 121-2 to the attribute prediction model 112, and obtains, as an output 515, an estimation probability distribution with respect to the second attribute. Also, the second training unit 1032 inputs a product image contained in the part of the second attribute training data 121-2 to the second attribute dedicated model 111-2, and obtains, as an output 516, an estimation probability distribution with respect to the second attribute. The second training unit 1032 obtains, with respect to the entirety of the part of the second attribute training data 121-2, the output 515 (estimation probability distribution) and the output 516 (estimation probability distribution), and calculates an evaluation value 517 (e.g., a KL divergence) based on the output 515 and the output 516. The second training unit 1032 trains the attribute prediction model 112 based on the evaluation value 517 (so that the evaluation value 517 is minimized, for example).

Furthermore, the second training unit 1032 inputs a product image contained in the full set of third attribute training data 121-3 to the attribute prediction model 112, and obtains, as an output 518, an estimation probability distribution with respect to the third attribute. The second training unit 1032 obtains, with respect to the entire third attribute training data 121-3, the output 518 (estimation probability distribution) and the correct answer probability distribution, and calculates an evaluation value 519 (for example, a cross entropy) based on the output 518 and the correct answer probability distribution. The second training unit 1032 trains the attribute prediction model 112 based on the evaluation value 519 (so that the evaluation value 519 is minimized, for example).

The second training unit 1032 stores the trained attribute prediction model 112 in the learning model storage unit 110.

FIG. 5D is a diagram illustrating a training procedure performed by the first training unit 1031 and the second training unit 1032 in the N-th time step. The training procedure shown in FIG. 5D corresponds to a generalized training procedure in each of the second time step to the N-th time step.

Similar to the procedure described with reference to FIGS. 5B and 5C, the first training unit 1031 inputs a full set of N-th attribute training data 121-N to the N-th attribute dedicated model 111-N, and trains the N-th attribute dedicated model 111-N based on an output 520 and an evaluation value 521.

Also, similar to the procedure described with reference to FIGS. 5B and 5C, the second training unit 1032 trains the attribute prediction model 112. The attribute prediction model 112 in the N-th time step is a learning model for predicting the first attribute to the N-th attribute. Taking the first attribute, the second attribute, and am (N−1)-th attribute as examples, the second training unit 1032 trains the attribute prediction model 112 based on an evaluation value 524, which is based on outputs 522 and 523 with respect to part of the first attribute training data 121-1, an evaluation value 527, which is based on outputs 525 and 526 of part of the second attribute training data 121-2, and an evaluation value 530, which is based on outputs 528 and 529 of part of the (N−1)-th attribute training data 121-(N−1). Furthermore, the second training unit 1032 inputs the full set of N-th attribute training data 121-N to the attribute prediction model 112, and trains the attribute prediction model 112 based on an output 531 and an evaluation value 532.

When a cross entropy and a KL divergence are used as evaluation values, a loss function L for use when the second training unit 1032 trains the attribute prediction model 112 in the N-th time step can be given as the expression (1).

$$L = ( 1 - α ) * CE ( {\hat{Y}}_{N} , {Y}_{N} ) + {\sum }_{i = 1}^{N - 1} α * {τ}^{2} * KL ( σ ( {Y}_{o}^{i} / τ ) , λ ( {\hat{Y}}_{o}^{i} / τ ) ) \qquad ( 1 )$$

Here, CE denotes cross entropy, KL denotes KL divergence, τ is temperature, σ is softmax function, λ is log-softmax function, and α is weight (balancing weight). Also, Yₒⁱ denotes an output from the i-th (i is an integer of 1 or more) attribute dedicated model. Y^{\hat{ }}ₒⁱ denotes an output with respect to the i-th attribute from the attribute prediction model 112. Y^{\hat{ }}_{N} denotes an output with respect to the N-th attribute from the attribute prediction model 112. Y_{N} denotes correct answer data with respect to the N-th attribute. As is clear from the expression (1), the loss function is based on the value obtained by multiplying each of the evaluation values (KL divergences) with respect to the first to (N−1)-th attributes by the weight α and summing up the products, and the value obtained by multiplying the evaluation value (cross entropy) with respect to the N-th attribute by the weight (1−α). The second training unit 1032 trains the attribute prediction model 112 so that the value derived from the loss function is optimized (for example, this value is minimized).

In this way, the training unit 103 trains the attribute prediction model 112 for predicting the first attribute to the N-th attribute, in accordance with knowledge distillation, with respect to the first attribute to the (N−1)-th attribute. Specifically, the training unit 103 trains the attribute prediction model 112, using the trained first attribute dedicated model 111-1 to the (N−1)-th attribute dedicated model 111-(N−1), which have been trained using full sets of training data with respect to the first attribute to the (N−1)-th attribute. With this, it is possible to train the attribute prediction model 112 so that catastrophic forgetting with respect to the first attribute to the (N−1)-th attribute is prevented.

Note that the attribute prediction model 112 trained in each of the second time step to the (N−1)-th time step may be stored in the learning model storage unit 110, while being distinguished from the attribute prediction model 112 trained in the N-th time step. The attribute prediction model 112 trained in the N-th time step is a learning model for predicting the first attribute to the N-th attribute, and the attribute prediction model 112 trained in the n-th (n is an integer of 2 or more and N−1 or less) time step is a learning model for predicting the first attribute to the n-th attribute.

### Modification of Learning Model Training Procedure

Although the procedures in the time steps have been described with reference to FIGS. 5A to 5D, the second training unit 1032 may train the attribute prediction model 112 for predicting the first attribute to the N-th attribute in a procedure different from the above-described procedures. This modification corresponds to processing of training only the attribute prediction model 112 for predicting the first attribute to the N-th attribute.

In the present modification, first, the first training unit 1031 trains the first attribute dedicated model 111-1 to the (N−1)-th attribute dedicated model 111-(N−1), using the first attribute training data 121-1 to the (N−1)-th attribute dedicated model 121-(N−1), respectively. The training procedure corresponds to a training procedure of the first training unit 1031 described with reference to FIGS. 5A to 5D, for example. Subsequently, the second training unit 1032 trains the attribute prediction model 112 in accordance with the procedure described with reference to FIG. 5D. Also with the training procedure according to the modification, it is possible to train the attribute prediction model 112 so that catastrophic forgetting with respect to the first attribute to the (N−1)-th attribute is prevented.

### Flow of Processing

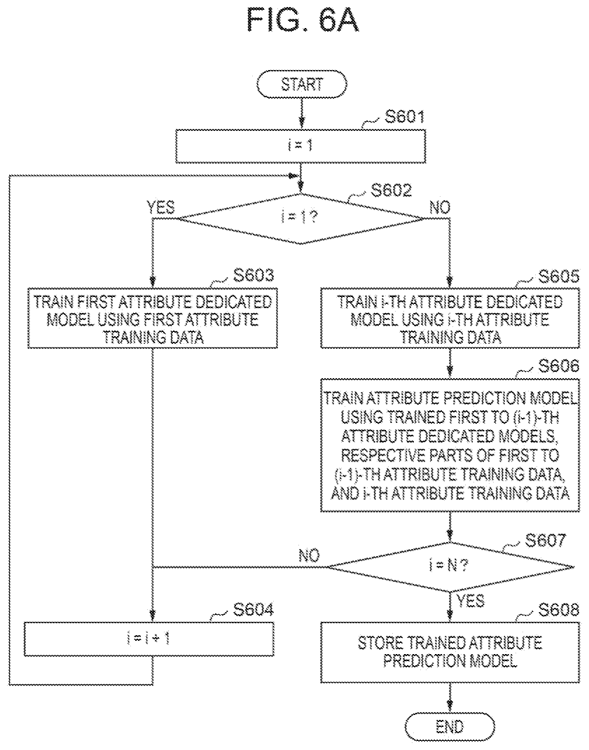

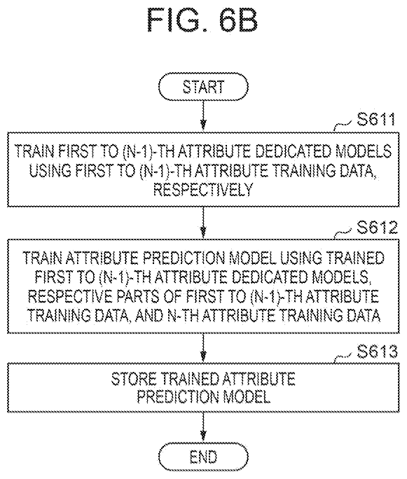

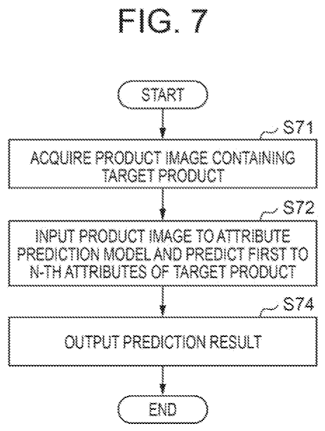

The following will describe a flow of processing executed by the information processing apparatus 100 according to the present embodiment, with reference to FIGS. 6A, 6B, and 7. The procedures shown in FIGS. 6A, 6B, and 7 can be realized by the CPU 21 of the information processing apparatus 100 loading programs stored in the ROM 22 or the like to the RAM 23 and executing it.

### (1-1) Processing of Training Attribute Prediction Model 112

FIG. 6A is a flowchart illustrating processing of training the attribute prediction model 112 for predicting the first attribute to the N-th attribute, the processing being executed by the information processing apparatus 100.

In S601, the training unit 103 sets a parameter i to 1. Here, i corresponds to a time step in the training procedure described with reference to FIGS. 5A to 5D. In S602, the training unit 103 determines whether or not i is 1. If i is 1 (Yes, in S602), the processing moves to S603, and otherwise (No, in S602), the processing moves to S605.

S603 is the training processing in the first time step. In S603, the first training unit 1031 trains the first attribute dedicated model 111-1 using the first attribute training data 121-1. The training procedure in S603 is as described with reference to FIG. 5A. After training the first attribute dedicated model 111-1, the first training unit 1031 stores the trained first attribute dedicated model 111-1 in the learning model storage unit 110. Then, in S604, the training unit 103 increments the parameter i. Thereafter, the processing moves to S602.

Steps S605 to S606 are training processing in an i-th (i is an integer of 2 or more) time step. In S605, the first training unit 1031 trains an i-th attribute dedicated model 111-i using an i-th attribute training data 121-i. After training the i-th attribute dedicated model 111-i, the first training unit 1031 stores the trained i-th attribute dedicated model 111-i in the learning model storage unit 110. Then, in S606, the second training unit 1032 trains the attribute prediction model 112, using the trained first to (i−1)-th attribute dedicated models 111-1 to 111-(i−1), respective parts of the first to (i−1)-th attribute training data 121-1 to 121-(i−1), and the i-th attribute training data 121-i. The training procedure in S606 is as described with reference to FIGS. 5B to 5D. After training the attribute prediction model 112, the second training unit 1032 can store the trained attribute prediction model 112 in the learning model storage unit 110. The second training unit 1032 may also store the attribute prediction model 112 trained in the i-th time step in the learning model storage unit 110 so that it is identifiable as a learning model for predicting the first attribute to the i-th attribute. Then, in S607, the training unit 103 determines whether or not the parameter i is N. If i is N (Yes, in S607), the processing moves to S608, and otherwise (No, in S607), the processing moves to S604.

In S608, the second training unit 1032 stores, in the learning model storage unit 110, the trained attribute prediction model 112 as a learning model for predicting the first attribute to the N-th attribute.

### (1-2) Processing of Training Attribute Prediction Model 112 (Modification)

The following describes an example of a modification of the processing in the above-described item (1-1). FIG. 6B is a flowchart illustrating a modification of the processing of training the attribute prediction model 112 executed by the information processing apparatus 100. As described above, this modification is processing of training only the attribute prediction model 112 for predicting the first attribute to the N-th attribute.

In S611, the first training unit 1031 trains the first attribute dedicated model 111-1 to the (N−1)-th attribute dedicated model 111-(N−1), using the first attribute training data 121-1 to the (N−1)-th attribute training data 121-(N−1), respectively. The training procedure in S611 is as described with reference to FIG. 5A. After training the first attribute dedicated model 111-1 to the (N−1)-th attribute dedicated model 111-(N−1), the first training unit 1031 stores the trained first to (N−1)-th attribute dedicated models 111-1 to 111-(N−1) in the learning model storage unit 110.

In S612, the second training unit 1032 trains the attribute prediction model 112, using the trained first to (N−1)-th attribute dedicated models 111-1 to 111-(N−1), respective parts of the first to (N−1)-th attribute training data 121-1 to 121-(N−1), and the N-th attribute training data 121-N. The training procedure in S612 is as described with reference to FIG. 5D.

In S613, the second training unit 1032 stores, in the learning model storage unit 110, the trained attribute prediction model 112 as a learning model for predicting the first attribute to the N-th attribute.

### (2) Processing of Predicting Attribute of Product Contained in Product Image.

After the above-described processing in the item (1-1) or (1-2), the information processing apparatus 100 predicts attributes of a product contained in a product image. FIG. 7 is a flowchart illustrating attribute prediction processing executed by the information processing apparatus 100. In this processing, the attribute prediction model 112 for predicting the first attribute to the N-th (N is an integer of 2 or more) attribute is used.

In S71, the image acquisition unit 104 acquires a product image containing a target product (product to be subjected to attribute prediction). For example, by an operator of the information processing apparatus 100 operating the information processing apparatus 100 to access a desired electronic commerce site and select a product image containing a target product, the image acquisition unit 104 acquires the product image. Also, by acquiring a product image or a URL (Uniform Resource Locator) indicating the product image transmitted from an external apparatus such as a user apparatus, the image acquisition unit 104 acquires the product image.

In S72, the attribute prediction unit 105 inputs the product image acquired by the image acquisition unit 104 to the trained attribute prediction model 112, and predicts N attributes of the first attribute to the N-th attribute of the target product contained in the product image. Specifically, the attribute prediction unit 105 extracts the types of the N attributes of the target product and predicts the features of the respective types of the N attributes.

In S73, the output unit 106 outputs information (attribute prediction result) on the attributes predicted by the attribute prediction unit 105. Specifically, the output unit 106 outputs the types of the N attributes and the features (feature values) of the respective types of the N attributes predicted by the attribute prediction unit 105. The output unit 106 may display the attribute production result on the display unit 26 (FIG. 2). Also, if a product image is acquired from an external apparatus such as a user apparatus, the output unit 106 may transmit an attribute production result to the external apparatus via the communication I/F 27 (FIG. 2) so that it is displayed on a display unit of the external apparatus.

In this way, when training the attribute prediction model 112 for predicting a plurality of attributes of a product from a product image containing the product, the information processing apparatus 100 according to the present embodiment trains the attribute prediction model 112 using, with respect to at least one attribute already trained, a dedicated learning model trained exclusively for the at least one attribute. With this, it is possible to train the attribute prediction model 112 with a new attribute, while preventing catastrophic forgetting.

Note that the present embodiment has described a learning model training procedure and an attribute prediction procedure, when a product image contains one product and a plurality of attributes of the product are to be predicted. When a product image contains a plurality of products, the information processing apparatus 100 may also be configured to divide the product image into sub-images respectively containing the products using known image recognition processing, perform the procedures described in the present embodiment on the sub-images, and predict a plurality of attributes.

Note that although a specific embodiment has been described above, the embodiment is a mere example and is not intended to limit the scope of the invention. The apparatus and method described in this specification may be implemented in forms aside from the embodiment described above. It is also possible to appropriately make omissions, substitutions, and modifications to the embodiment described above without departing from the scope of the invention. Implementations with such omissions, substitutions, and modifications are included in the scope of the patent claims and their equivalents, and belong to the technical scope of the present invention.

The disclosure includes the following embodiments.
[1] An information processing apparatus comprising, a training unit configured to train an attribute prediction model for predicting, from an image containing a product, N (N is an integer of 2 or more) attributes of the product, wherein the training unit includes: a first training unit configured to train an i-th (i is an integer of 1 to N−1) learning model for predicting an i-th attribute of the product, using i-th training data corresponding to the i-th attribute; and a second training unit configured to train the attribute prediction model using the i-th learning model trained by the first training unit, part of the i-th training data, and N-th training data corresponding to an N-th attribute of the product.
[2] The information processing apparatus according to [1], wherein the first training unit trains the i-th learning model using an estimation result for the i-th attribute obtained by applying the i-th training data to the i-th learning model.
[3] The information processing apparatus according to [2], wherein the first training unit trains the i-th learning model using an evaluation value obtained based on the estimation result for the i-th attribute.
[4] The information processing apparatus according to [3], wherein the evaluation value is a cross entropy.
[5] The information processing apparatus according to any one of [1] to [4], wherein the second training unit trains the attribute prediction model using: first estimation results for a first attribute to an (N−1)-th attribute obtained by applying the part of the i-th training data to the i-th learning model; and second prediction results for the first attribute to the N-th attribute obtained by applying the part of the i-th training data and the N-th training data to the attribute prediction model.
[6] The information processing apparatus according to [5], wherein the second training unit trains the attribute prediction model using: the first estimation results for the first attribute to the (N−1)-th attribute; (N−1) first evaluation values obtained based on the second prediction results for the first attribute to the (N−1)-th attribute, and a second evaluation value obtained based on the second prediction result for the N-th attribute.
[7] The information processing apparatus according to [6], wherein each of the (N−1) first evaluation values is a KL divergence, and the second evaluation value is a cross entropy.
[8] The information processing apparatus according to [7], wherein the second training unit trains the attribute prediction model using a loss function that is based on a value obtained by multiplying each of the (N−1) first evaluation values by a weight α and summing up the products, and a value obtained by multiplying the second evaluation value by a weight (1−α).
[9] The information processing apparatus according to any one of [1] to [8], further comprising: an acquisition unit configured to acquire an image containing a target product; and a prediction unit configured to predict a first attribute to an N-th attribute of the target product, by inputting the image acquired by the acquisition unit to the attribute prediction model trained by the second training unit.
[10] An information processing method for training an attribute prediction model for predicting, from an image containing a product, N (N is an integer of 2 or more) attributes of the product, the method comprising the steps of: training an i-th (i is an integer of 1 to N−1) learning model for predicting an i-th attribute of the product, using i-th training data corresponding to the i-th attribute; and training the attribute prediction model using the i-th learning model trained by the first training unit, part of the i-th training data, and N-th training data corresponding to an N-th attribute of the product.
[11] An information processing program for training an attribute prediction model for predicting, from an image containing a product, N (N is an integer of 2 or more) attributes of the product, the program causing a computer to execute the steps of: training an i-th (i is an integer of 1 to N−1) learning model for predicting an i-th attribute of the product, using i-th training data corresponding to the i-th attribute; and training the attribute prediction model using the i-th learning model trained by the first training unit, part of the i-th training data, and N-th training data corresponding to an N-th attribute of the product.

### REFERENCE NUMERALS AND SYMBOLS

100: Information processing apparatus
101: Training data acquisition unit
102: Training data management unit
103: Training unit
1031: First training unit
1032: Second training unit
104: Image acquisition unit
105: Attribute prediction unit
106: Output unit
110: Learning model storage unit
111-1: First attribute dedicated model
111-N: N-th attribute dedicated model
112: Attribute prediction model
120: Attribute data storage unit
121-1: First attribute training data
121-N: N-th attribute training data

1. An information processing apparatus comprising,
at least one memory configured to store program code; and
at least one processor configured to operate as instructed by the program code, the program code including:
training code configured to cause at least one of the at least one processor to train an attribute prediction model for predicting, from an image containing a product, N (N is an integer of 2 or more) attributes of the product,
wherein the training code includes:
first training code configured to cause at least one of the at least one processor to train an i-th (i is an integer of 1 to N−1) learning model for predicting an i-th attribute of the product, using i-th training data corresponding to the i-th attribute; and
second training code configured to cause at least one of the at least one processor to train the attribute prediction model using the i-th learning model, part of the i-th training data, and N-th training data corresponding to an N-th attribute of the product.

2. The information processing apparatus according to claim 1,
wherein the first training code is configured to cause at least one of the at least one processor to train the i-th learning model using an estimation result for the i-th attribute obtained by applying the i-th training data to the i-th learning model.

3. The information processing apparatus according to claim 2,
wherein the first training code is configured to cause at least one of the at least one processor to train the i-th learning model using an evaluation value obtained based on the estimation result for the i-th attribute.

4. The information processing apparatus according to claim 3,
wherein the evaluation value is a cross entropy.

5. The information processing apparatus according to claim 1,
wherein the second training code is configured to cause at least one of the at least one processor to train the attribute prediction model using:
first estimation results for a first attribute to an (N−1)-th attribute obtained by applying the part of the i-th training data to the i-th learning model; and
second estimation results for the first attribute to the N-th attribute obtained by applying the part of the i-th training data and the N-th training data to the attribute prediction model.

6. The information processing apparatus according to claim 5,
wherein the second training code is configured to cause at least one of the at least one processor to train the attribute prediction model using:
the first estimation results for the first attribute to the (N−1)-th attribute;
(N−1) first evaluation values obtained based on the second estimation results for the first attribute to the (N−1)-th attribute, and
a second evaluation value obtained based on the second estimation result for the N-th attribute.

7. The information processing apparatus according to claim 6,
wherein each of the (N−1) first evaluation values is a KL divergence, and the second evaluation value is a cross entropy.

8. The information processing apparatus according to claim 7,
wherein the second training code is configured to cause at least one of the at least one processor to train the attribute prediction model using a loss function that is based on a value obtained by multiplying each of the (N−1) first evaluation values by a weight α and summing up the products, and a value obtained by multiplying the second evaluation value by a weight (1−α).

9. The information processing apparatus according to claim 1, further comprising:
acquisition code configured to cause at least one of the at least one processor to acquire an image containing a target product; and
prediction code configured to cause at least one of the at least one processor to predict a first attribute to an N-th attribute of the target product, by inputting the image acquired to the attribute prediction model.

10. An information processing method for training an attribute prediction model for predicting, from an image containing a product, N (N is an integer of 2 or more) attributes of the product, the method performed by at least one processor and comprising:
training an i-th (i is an integer of 1 to N−1) learning model for predicting an i-th attribute of the product, using i-th training data corresponding to the i-th attribute; and
training the attribute prediction model using the i-th learning model, part of the i-th training data, and N-th training data corresponding to an N-th attribute of the product.

11. A non-transitory computer readable medium storing an information processing program for training an attribute prediction model for predicting, from an image containing a product, N (N is an integer of 2 or more) attributes of the product, the program causing a computer to execute the steps of:
training an i-th (i is an integer of 1 to N−1) learning model for predicting an i-th attribute of the product, using i-th training data corresponding to the i-th attribute; and
training the attribute prediction model using the i-th learning model, part of the i-th training data, and N-th training data corresponding to an N-th attribute of the product.
